(19) United States
(12) Patent Application Publication
(10) Pub. No.: US 2025/0001299 A1
(43) Pub. Date: Jan. 2, 2025

(54) Method for Controlling Virtual Weapon, Electronic Device, Storage Medium, and Computer Program Product

(71) Applicant: Shanghai Lilith Technology Corporation, Shanghai (CN)

(72) Inventors: Hao Meng, Shanghai (CN); Guanyu Feng, Shanghai (CN); Peixuan Huang, Shanghai (CN); Xiaowei Kong, Shanghai (CN); Yujing Lyu, Shanghai (CN); Ming Fang, Shanghai (CN)

(21) Appl. No.: 18/264,222

(22) PCT Filed: Aug. 31, 2022
(86) PCT No.: PCT/CN2022/116139

§ 371 Date: Aug. 3, 2023

(51) Int. Cl. A63F 13/537; A63F 13/837

(52) U.S. Cl. CPC A63F 13/537; A63F 13/837

(57) ABSTRACT

The present invention belongs to the technical field of electronic games, and has specifically disclosed a method for controlling a virtual weapon, applied to a client device, including: when the virtual weapon enters an aiming state, displaying a standard front sight state of a front sight of the virtual weapon on the client device, where a center point of the standard front sight state points to a target to be aimed at; and when an attribute of the virtual weapon changes in response to a firing operation, correspondingly change a display state of the front sight on the client device, where the display state includes at least one of the followings: shape of the front sight, color of the front sight, and dynamic changes of the display state. An advantage of the present invention is that gaming experience of a player is further improved.

### TECHNICAL FIELD

The present invention relates to the technical field of electronic games, in particular, to a method for controlling a virtual weapon, an electronic device, a storage medium, and a computer program product.

### BACKGROUND

As the gameplay design of shooting games becomes more abundant, game experience pursued by players is getting closer to the real feeling of using weapons.

In the prior art, in order to improve experience of the player, various attributes of the weapon are usually displayed on a display interface of a game, to help the player to accurately control the weapon. At the same time, the shooting games inevitably display a front sight on the display interface of the game.

The weapon attributes and the front sight are respectively displayed in different areas of the display interface. As a result, too much screen area is occupied and a utilization rate of a screen is reduced. In addition, the player needs to repeatedly adjust a perspective in a fast-paced battle to pay attention to the content of the attributes and a target to aim at.

Therefore, the above design is not conducive to further improving game experience of the player.

### SUMMARY

In order to solve the above defects and further improve experience of a player, the present invention proposes a technical solution for graphically and dynamically displaying weapon attributes around a front sight.

The present invention first proposes a method for displaying attribution of a virtual weapon, applied to a client device, including:
when the virtual weapon enters an aiming state, displaying a standard front sight state of a front sight of the virtual weapon on the client device, where a center point of the standard front sight state points to a target to be aimed at; and
when an attribute of the virtual weapon changes in response to a firing operation, correspondingly change a display state of the front sight on the client device, where the display state includes at least one of the followings: shape of the front sight, color of the front sight, and dynamic changes of the display state.

In the above display method, when the firing operation triggers a charge attack skill, the display state of the front sight is changed to a first display state for indicating the degree of charge, and the first display state includes displaying a process in which a first circle gradually appears from the 0 o'clock position to the 12 o'clock position by using the center point of the standard front sight state as a center of the first circle.

In the above display method, when the firing operation meets a heating condition of the virtual weapon, the display state of the front sight is changed to a second display state for indicating a degree of heating of the virtual weapon, and the second display state includes: with the increase of the degree of heating, displaying a second circle whose radius gradually expands by using the center point of the standard front sight state as a center of the second circle, and when the degree of heating reaches a predetermined first threshold, fixing a radius of the second circle as a preset maximum radius.

In the above display method, when the firing operation does not meet the heating condition, the second display state further includes: with the decrease of the degree of heating, displaying a process in which the second circle gradually shrinks to the center of the second circle.

In the above display method, when the radius of the second circle is fixed as a preset maximum radius, the second display state further includes: with the decrease of the degree of heating, displaying a process in which a circle with the maximum radius gradually disappears in a counterclockwise direction from the 12 o'clock position to the 0 o'clock position.

In the above display method, when multiple attributes of the virtual weapon simultaneously change, multiple display states are simultaneously displayed on the client device.

In the above display method, the display state of the front sight further includes a third display state for indicating the current quantity of ammunition, and the third display state includes: displaying multiple arcs around the central point of the standard front sight state, where the multiple arcs are located on the same virtual circle that uses the center point as a center of the virtual circle, and one arc represents one piece of ammunition.

In the above display method, when it is preset to keep displaying the quantity of ammunition, the front sight keeps displaying the third display state; and when it is not preset to keep displaying the quantity of ammunition, the front sight displays the third display state in response to the aiming operation until the firing operation is completed.

In the above display method, the multiple arcs include a first arc, a first frame line having a color different from the color of the first arc is arranged on one side of the first arc, and when the ammunition corresponding to the first arc is used, only the first frame line is displayed.

In the above display method, the multiple arcs include a second arc having a first color, and when the ammunition corresponding to the second arc is used, the color of the second arc is displayed as a second color.

In the above display method, in response to an operation of replenishing the ammunition, the third display state further includes: displaying a newly added arc at a gap between the multiple arcs, and displaying the newly added arc in a color different from that of the multiple arcs; simultaneously shrinking, by the newly added arc and the multiple arcs, toward the center of the virtual circle, so that the newly added arc is embedded between the multiple arcs; taking, by the front sight in the third display state, the center point of the standard front sight state as a center of a circle, and rotating a predetermined angle around the center of the circle; and simultaneously expanding the newly added arc and the multiple arcs in a direction away from the center of the circle, and when the expansion ends, displaying no multiple arcs, and displaying only the newly added arc.

Based on the same inventive concept, the present invention further provides an electronic device, including:
at least one memory, configured to store a set of computer instructions; and
at least one processor, configured to: when the at least one processor executes the computer instructions, implement the display method.

Based on the same inventive concept, the present invention further provides a computer-readable storage medium, at least one computer instruction is stored in the computer-readable storage medium, and the at least one instruction is loaded and executed by the processor, to implement the display method.

Based on the same inventive concept, the present invention further provides a computer program product, the computer program product includes a computer program or a set of instructions, and when the computer program or instructions are executed by the processor, the display method is implemented.

Compared with the prior art, in the technical solution proposed in the present application, weapon attributes are combined with a front sight by using graphics, color and a dynamic display method, so that a line of sight of a player can always be kept within a range of the front sight during a process of aiming at the target, and a variety of pieces of information about the attributes of weapons can be obtained at the same time. Therefore, the player can judge the situation more keenly in the battle and make correct decisions. In this way, the present invention further improves gaming experience of the player.

### BRIEF DESCRIPTION OF DRAWINGS

FIG. 1 is a schematic structural diagram of basic hardware of an electronic device according to some embodiments of the present application;

FIG. 2 is a flowchart of a method for displaying attributes of a virtual weapon according to some embodiments of the present application;

FIG. 3 is an image of a standard front sight state;

FIG. 4 is a prompt of a charging process of a virtual weapon;

FIG. 5 is a prompt of a heating process of a virtual weapon;

FIG. 6 is a prompt of a cooling process of a virtual weapon;

FIG. 7 is a prompt of an ammunition consumption process of a virtual weapon in a shooting process;

FIG. 8 is a prompt of a process of changing a cartridge clip of a virtual weapon;

FIG. 9 is an image of a front sight displayed when the quantity of ammunition is added on the basis of FIG. 3;

FIG. 10 is a prompt of an ammunition consumption process of a virtual weapon in a continuous shooting process; and

FIG. 11 is a prompt of another cooling process of a virtual weapon.

### DETAILED DESCRIPTION

The implementations of the present invention are described below by using specific embodiments, and a person skilled in the art can easily understand other advantages and effects of the present invention from the contents disclosed in this description. Although the description of the present invention is presented in conjunction with the preferred embodiment, this does not mean that the features of the present invention are limited to this implementation. On the contrary, the purpose of introducing the present invention in conjunction with the embodiments is to cover other options or modifications that may be extended based on the claims of the present invention. The following description contains numerous specific details in order to provide a thorough understanding of the present invention. The present invention may also be practiced without these details. Furthermore, some specific details are omitted from the description in order to avoid confusing or obscuring the gist of the present invention. It should be noted that the embodiments of the present invention and the features of the embodiments may be combined with each other under the condition of no conflict.

It should be noted that in this description, similar numerals and letters refer to similar items in the following figures. Therefore, once an item is defined in one figure, there is no need to define the item in subsequent figures for further definitions and explanations, and the item in the subsequent figures has the same definition by default.

In order to make the objectives, technical solutions and advantages of the present invention clearer, the implementations of the present invention are further described in detail below with reference to the accompanying drawings.

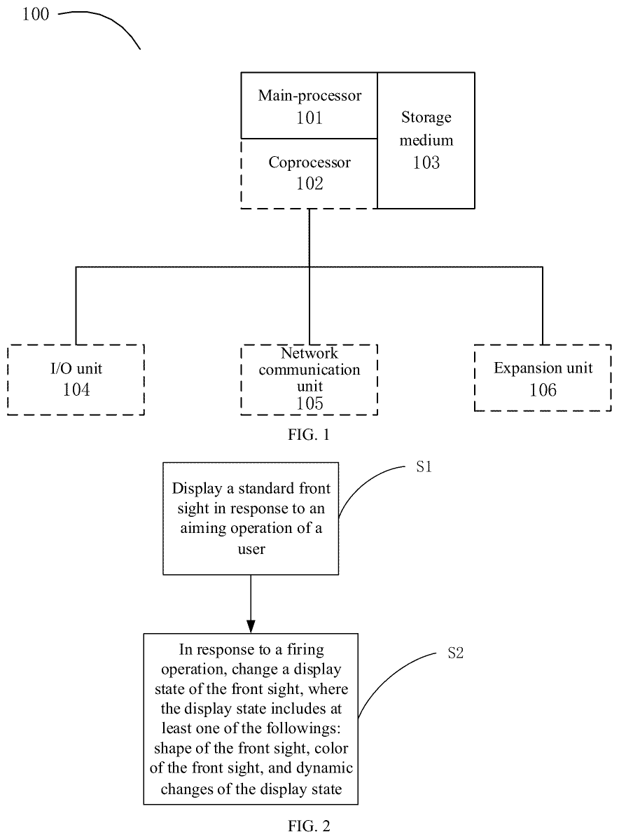

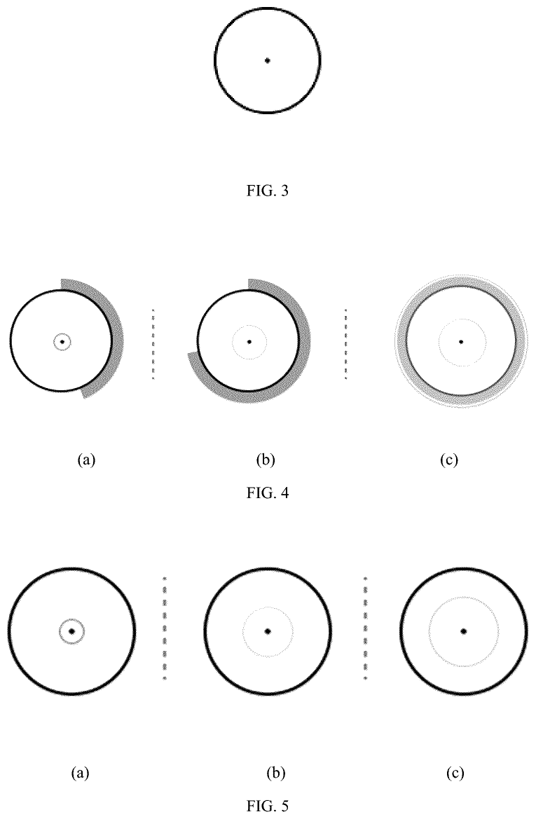

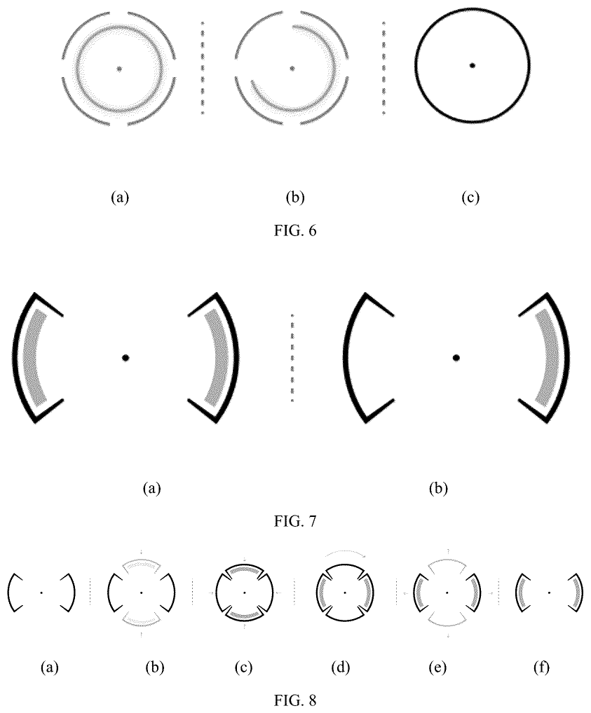

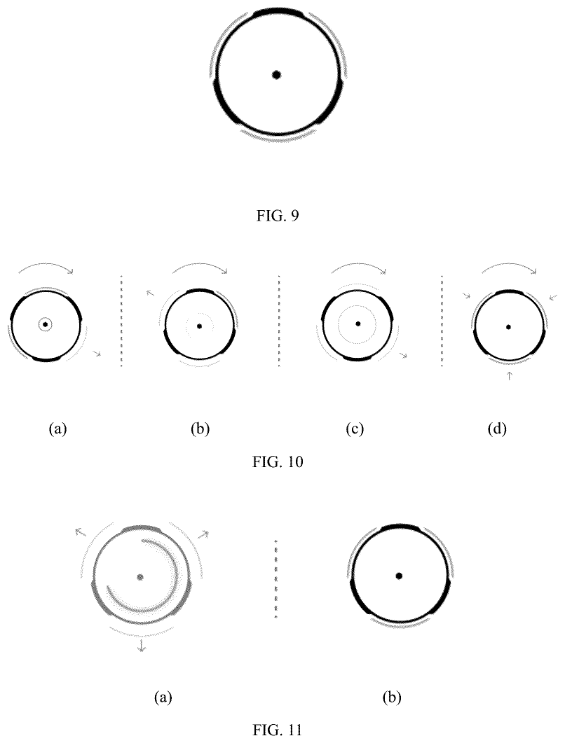

The embodiments of a method for controlling a virtual weapon provided by the present invention may be applied in various client devices. For example, the client device may be an electronic device such as a mobile phone, a computer, and a PAD. FIG. 1 is a schematic structural diagram of basic hardware of an electronic device 100.

As shown in FIG. 1, the electronic device 100 includes at least a main processor 101 and a storage medium 103. According to different actual usage requirements, the electronic device 100 may further include a coprocessor 102, an I/O unit 104, a network communication unit 105 and some other expansion units 106. The options of the coprocessor 102, the I/O unit 104, the network communication unit 105 and other expansion units 106 are shown in dotted lines in the figure.

The main processor 101 and/or the coprocessor 102 are used to execute a set of instructions stored in the storage medium 103 to implement the method proposed in the present invention. The main processor 101 is a control center of the electronic device 100, and is usually a general-purpose processor (for example, various series of Intel CPUs), so that logic processing and arithmetic calculation can be implemented in a relatively balanced manner. The main processor 101 is connected to various parts of the entire electronic device 100 by using various interfaces, and various functions of the electronic device 100 are implemented by running or executing a software program stored in the storage medium 103 and calling data stored in the storage medium 103.

The coprocessor 102 is usually a dedicated processor (for example, a user-programmable embedded microprocessor) used to implement a single function. For example, the coprocessor 102 may be a graphics processing unit (GPU, Graphics Processing Unit) dedicated to processing graphic images. The main processor 101 does not directly process information about graphic images at this time, but provides data from other units to the coprocessor 102 or sends a management instruction to the coprocessor 102 to instruct the coprocessor 102 to obtain data from other units. Moreover, after the coprocessor 102 finishes processing the data, the main processor 101 receives a processing result from the coprocessor 102, to subsequently make other determinations based on the processing result. For different professional fields, the coprocessor 102 may further be a signal processor, a network communication processor, a complex calculation processor, and the like. Usually, the hardware implementation basis of the coprocessor 102 is a digital signal processing (DSP, Digital Signal Processing) chip, or an application-specific integrated circuit (ASIC, Application-Specific Integrated Circuit) such as a complex programmable logic device (CPLD, Complex Programmable Logic Device) and a field-programmable gate array (FPGA, Field-Programmable Gate Array).

The storage medium 103 may include an internal memory and an external memory, or may include a volatile memory and a nonvolatile memory, or may include a magnetic storage device, a solid state memory, a flash memory, a floppy disk, a hard disk, and the like. The storage medium 103 can be used to store an operating system (for example, can be executed by the main processor 101) and data generated by the operating system in a running process, a software program of the application software and data generated by the application software in a running process, a software program of a dedicated module (for example, may be executed by a coprocessor 102) and data generated by the program in a running process. For example, in one embodiment of the present invention, the main processor 101 executes various functional applications and performs data processing by running a monitoring program stored in the storage medium 103. In some embodiments, the storage medium 103 may further be a remote memory (relative to a memory in the usual sense) that is set remotely relative to the main processor 101, and these remote memories can be connected to the main processor 101 or a certain coprocessor 102 through network connection (for example, by using the network communication device 105). An example of the network includes, but is not limited to, the Internet, intranet, a local area network, a mobile communication network, and a combination thereof.

The I/O (Input/Output, input and output) unit 104 includes an information input device and an information output device, so that a user can interact with the electronic device 100. The input device can be used to receive inputted digital or character information, and specifically may include: a keyboard, a mouse, a joystick, a touch input device, or a trackball. The output device may be used to output/display a processing result obtained by processing by the electronic device 100, and the processing result may be made according to the information inputted by the input device. Specifically, the output device may include: a liquid crystal display (Liquid Crystal Display, LCD), an organic light-emitting diode (Organic Light-Emitting Diode, OLED), and the like.

The network communication unit 105 implements communication between the electronic device 100 and various remote devices through the connection of a wired/wireless network, so that the electronic device 100 can further exchange data with the remote device (for example, the remote memory). Alternatively, the electronic device 100 can implement the connection to the server by using the network communication unit 105, so that the electronic device 100 can interact with the server as a part of a large-scale system.

The expansion unit 106 includes various peripheral components and interfaces, so that the electronic device 100 can interact with various devices. For example, the electronic device 100 can be connected to a Bluetooth headset through a Bluetooth interface, so that the audio played by the electronic device 100 can be received by the Bluetooth headset. For another example, the electronic device 100 can be connected to some sensors by using a bus interface (such as an RS-485 bus), so that some monitoring data is obtained to assist the electronic device 100 to implement specific functions. In various embodiments, the expansion unit 106 may exist independently, or may be integrated with other components of the electronic device 100. Meanwhile, the expansion unit 106 is optional, and optional properties thereof are indicated by dotted lines in the figure.

FIG. 2 is a flowchart of a method for controlling a virtual weapon according to some embodiments of the present application.

In S1, when a virtual weapon is in an aiming state after a user (player) operation is performed on the virtual weapon, a front sight of the virtual weapon is displayed on a client device on which a game is run, and the front sight can be in a standard front sight state. The client device is the electronic device 100 shown in FIG. 1, the client device includes a touch screen (that is, the I/O unit 104 in FIG. 1, the touch screen belongs to an I/O device), and the touch screen is used to display an application program interface. For example, for a front sight in a shooting game, the user can perform operations such as clicking, double clicking, long pressing, and sliding on the touch screen, and the touch screen gives the main processor 101 feedback after receiving the above operations. The standard front sight state can be a circle as shown in FIG. 3 and a center point at a center (circle center) of the circle, the circle indicates an aiming range of the virtual weapon, and the center point indicates a center of the aiming range, and points to a target to be aimed at. Alternatively, the standard front sight state can also be shown in a shape of a cross, and a cross point of the cross is equivalent to a center point of the front sight (similar to a position of the circle center shown in FIG. 3), and is used to indicate the target to be aimed at. The virtual weapon can be a weapon such as a rifle, a submachine gun, or an energy gun in a shooting game, can be controlled and operated by a user, and can be in a state such as a standby state, an aiming state, or a shooting state. The standby state refers to a standby state when the user controls a virtual character to move or the virtual weapon is in a backpack. When the user controls the virtual character to hold the virtual weapon to perform aiming, the virtual weapon enters the aiming state from the standby state, and a certain type of virtual weapon enters the aiming state when a scope is turned on. When the user performs a firing operation, the virtual weapon enters the shooting state.

In S2, when the virtual weapon enters the aiming state, the user performs some operations on the virtual weapon, such as a firing operation (also referred to as a shooting operation), so that the attributes of the virtual weapon change. For example, when the user performs an operation similar to “charge attack”, the virtual weapon needs a period of time to accumulate energy, and then can burst into a more violent attack behavior, and in this case, the energy attribute of the virtual weapon changes. This change can be correspondingly reflected in the change of the display state of the front sight (for specific changes, please refer to the description of FIG. 3-FIG. 11 below). The display state of the front sight includes changing the shape and color of the state of the front sight, or a dynamic change process of the shape and color. For example, a color includes three elements: hue, brightness, and saturation. Changing the display state of the front sight can be changing the brightness of the color, or can be a process of gradually changing the displayed color from brighter to darker. In some embodiments, a change process in which the front sight is changed from one form to another form can further be displayed dynamically.

Specifically, when the firing operation performed by the user triggers a charge attack skill, the client device displays a first display state for indicating the degree of charging. The charge attack skill is a skill that appears on a condition that accumulating or waiting for a period of time is required to make a certain attribute of the virtual weapon accumulate and rise. This attribute has an upper limit value. When the attribute reaches the upper limit value, the degree of charge synchronously reaches the upper limit. After that, even if the charge attack skill is continued to be used, the degree of charge can no longer be increased. The first display state includes displaying a process in which a first circle that uses the center point of the standard front sight state as a center of the first circle gradually appears from 0° to 360°, and a radius of the first circle may be larger than a radius of the circle in the standard front sight state, or may be smaller than or equal to a radius of the circle in the standard front sight state. That is, the first display state uses a process in which the first circle begins from scratch until the first circle becomes closed to indicate an accumulation process of the degree of charge, that is, the energy accumulation process of the energy weapon, and when the first circle is closed, the degree of charge and the corresponding attribute of the virtual weapon have reached the upper limit. Preferably, the first circle may partially overlap with the circle in the standard front sight state shown in FIG. 3. FIG. 4 shows a prompt of a charging process of a virtual weapon. (a)˜ (c) in FIG. 4 show a process in which the ring (which can be regarded as a circle with a wider frame) overlapping with the circle of the standard front sight starts from the 12 o'clock position and gradually becomes enclosed and connected in an end-to-end manner in a clockwise direction, that is, a process in which the virtual weapon, especially an energy weapon changes from a state of lacking energy to a state of having sufficient energy. The end-to-end connection indicates that the first attribute of the virtual weapon (that is, the attribute of attack power) has reached the highest level, that is, the degree of charge has reached the maximum. In addition, after the ring is closed (as shown in FIG. 4(c)), in a color interface, the color of the whole ring is brighter than that of the rings in FIG. 4(a) and FIG. 4(b), and a halo effect can further be made to remind the user that the charging process is over, and the player can use a charge attack skill with full damage capacity. In addition, in some other embodiments, the process of charging may further be accompanied by an effect that the color of the circle changes from light to dark, that is, a process of gradually increasing the saturation of the color. The changing from light to dark includes changing the overall color of the circle from light to dark, and gradually changing from light to dark along a circumferential direction.

A real gun weapon generates heat during continuous firing in a short period of time, and therefore a situation that the virtual weapon is overheated due to the firing operation causes the virtual weapon to overheat is also considered in the technical solution protected by the present application. When the firing operation meets a heating condition of the virtual weapon, the client device displays a second display state in which the front sight is used to indicate the degree of heating of the virtual weapon. The heating condition includes continuously performing firing multiple times, for example, continuously performing firing 3 times. Alternatively, firing is performed multiple times in an accumulated manner in a predetermined short period of time. For example, firing is performed 5 times in 1 minute in an accumulated manner, this time dimension can be defined by a game designer, or firing can be performed 5 times within 1 second in an accumulated manner, or can be performed 5 times within 10 seconds in an accumulated manner. Specifically, firing is continuously performed indicates that an interval time between two firing operations is less than a predetermined first time. For example, if the first time is set to be 0.2 seconds, when the time interval between two adjacent firing operations is less than 0.2 seconds, it can be considered that the two adjacent firing operations are continuously performed. Firing is performed multiple times indicates that more than two firing operations are performed. That is, firing is continuously performed multiple times indicates that firing operations that the interval times between more than two adjacent firings are all shorter than the first time are performed.

The second display state includes the following contents: With the increase of the heating degree, a second circle whose radius gradually expands is displayed by using the center point of the standard front sight state as a center of the second circle, and when the heating degree reaches a predetermined first threshold, the radius of the second circle is fixed to be a preset maximum radius. That is, when a temperature of the virtual weapon reaches or exceeds a threshold temperature, the circle used to indicate the degree of overheating also reaches the maximum radius and does not continue to expand. In this case, the virtual weapon enters an overheated state, and the virtual weapon that enters an overheated state does not support the firing operation and must forcibly be cooled down.

FIG. 5 shows a prompt of a heating process of a virtual weapon. When the user performs a firing operation multiple times in a row, that is, triggers a shooting button multiple times, a gun barrel of the virtual firearm becomes hot or even overheated. (a)˜ (c) in FIG. 5 sequentially display the second circle whose radius gradually increases to indicate that the temperature of the virtual weapon gradually increases. In FIG. 5(a), only two bullets may be used by the user, there is only a little heating effect on the gun barrel, and therefore a small second circle is displayed by using the center point of the standard front sight as a center of the second circle. In FIG. 5(b), a firing operation is performed continuously and five bullets may be used by the user, and the gun barrel is caused to be hotter, and therefore a second circle with a slightly larger radius is shown. Similarly, in FIG. 5(c), a second circle with a larger radius indicates more heat has been accumulated. Until the heat caused by firing bullets in the continuous firing operations exceeds a predetermined first threshold and reaches the degree of overheating, the virtual weapon enters an overheated state, and in this overheated state, the user cannot continue performing the firing operation. Therefore, the second circle with the maximum radius is displayed statically (that is, expanding the radius of the circle is stopped), as shown in FIG. 6(a), in this case, gaps are shown at four positions of 3 o'clock, 6 o'clock, 9 o'clock and 12 o'clock corresponding to the standard front sight state, and this indicates that the firing operation cannot be performed.

Further, different shades of colors are further set on the second circle shown in FIGS. 5(a)-(c) and FIG. 6(a), and the color changes from light to dark, and this indicates the increase of heat (the process is more clearly displayed on the color interface). Furthermore, the largest and darkest second circle shown in FIG. 6(a) can further increase the brightness and make the largest and darkest second circle more attractive to eyes of the user than other surrounding patterns or lines by using more vivid colors, so as to more effectively remind the player that the firearm is overheated. When the gun barrel enters the overheated state, the firing operation of the user is prohibited, and the firing operation can be started only when the temperature of the gun barrel returns to the predetermined second threshold. Referring to FIGS. 6(a)-(c), the second circle with a halo effect in FIG. 6 gradually disappears in a counterclockwise direction, and this indicates that the temperature gradually decreases. When the temperature returns to the second threshold, the second circle completely disappears (as shown in FIG. 6(c)), and this indicates that the temperature is lower than the second threshold and reaches a safe level, and the virtual weapon can start shooting again.

Contrary to the heating process in FIGS. 5(a)-(c), when the player stops continuously performing the firing operation multiple times, that is, the current firing operation does not meet the heating condition of the virtual weapon, and the virtual weapon is not in the overheated state (that is, the degree of heating does not exceed the first threshold), the second display state of the front sight includes a process of displaying the second circle from large to small according to the radius of the second circle, as shown in FIGS. 5(c)-(a). When the pause between two firing operations becomes longer, the heat on the barrel subsides more obviously. Until there is no heat, the front sight returns to the standard front sight state.

FIG. 6 shows a process in which the virtual weapon cools down after entering the overheated state (that is, a state in which the heating degree of the virtual weapon has reached the first threshold and thus the virtual weapon is prohibited from shooting). The cooling process is also a timing process, and indicates a process in which the second circle indicating heat gradually disappears from the overheated state shown in FIG. 6(a) in the counterclockwise direction from the 12 o'clock position within the predetermined cooling time, as shown in FIGS. 6(a)-(c). After the second circle disappears completely, the front sight returns to the standard front sight state, and the gaps at the four positions on the circle of the aiming range corresponding to the front sight are also filled, and this indicates that the overheated state is released, and the virtual weapon can accept the firing operation.

Further, the heating display state shown in FIG. 5 can be simultaneously displayed with other display states without conflicting with other display states. For example, as shown in FIGS. 4(a)-(c), while the charge process is displayed (that is, while the first circle is displayed), the second circles around the center of the circle from small to large are displayed in turn to indicate the heat generation. In this case, the charge process also generates heat to heat up the virtual weapon until the virtual weapon enters an overheated state. The front sight of the virtual weapon displays the above first display state and second display state that are corresponding to an attack power attribute related to the charge attack skill and a temperature attribute related to the heat.

When the virtual weapon supports the display of the ammunition quantity, the front sight may further be displayed as a third display state for indicating the current ammunition quantity. The prerequisite for the appearance of the third display state may be as follows: The setting of keeping displaying the ammunition quantity is preset in the system, or the user modifies the configuration options in the game, so that the ammunition quantity remains displayed. Then, when the front sight appears, the third display state is always displayed synchronously on the client device. When keeping displaying the ammunition quantity is not set in the system, the third display state may appear in response to the aiming operation and exit after the shooting operation is completed. That is, according to different system settings, the ammunition quantity can be displayed all the time, or can be displayed temporarily for a period of time with certain operations.

Specifically, the third display state includes: Multiple arcs are displayed around the center point of the standard front sight state, the multiple arcs are located on the same circle that uses the center point as a center of the circle, and an arc represents a piece of ammunition. Specifically, whether the arc is filled with a color block or the depth of the color are used to be corresponding to whether the piece of ammunition is used. In some embodiments, in addition to the arc body, the arc may further include a half-enclosed or fully-enclosed frame line disposed on an outer periphery of the arc, such as an outer frame or an inner frame. When the color block filled in the arc disappears or the color becomes lighter, it indicates that the piece of ammunition has been used up. As shown in FIG. 7(a), a half-enclosed outer frame is set on the outer periphery of two wider solid arcs (in other embodiments, the outer frame can be a fully-enclosed outer frame, or a virtual frame. Alternatively, in the colored interface, the arc can further display color, such as yellow), the left arc is a first arc, and an outer side of the first arc half surrounds the first frame line, the right arc is a second arc, and an outer side of the second arc half surrounds the second frame line. When the ammunition corresponding to the first arc and the second arc is not used, the arc filling color block and the outer frame are displayed at the same time (as shown in FIG. 7 (a)), and when the ammunition corresponding to the first arc has been used up, only the first frame line (as shown in the left half side of FIG. 7(b)) is displayed, and the filling color block corresponding to the first arc is not displayed. For another example, as shown in FIG. 10(a), a virtual weapon with triple-loaded ammunition is displayed, the ammunition at the 12 o'clock position and the 8 o'clock position are unused, and the color of the corresponding arc is displayed in dark gray (the color of the arc can be displayed as a relatively bright yellow in the color interface), and the ammunition at the 4 o'clock position has been used, then the color of the corresponding second arc is displayed from the first color that is dark gray before the ammunition is used to the second color that is light gray, and the second arc spreads out some distance away from the virtual circle (the color of the arc can be displayed as a lighter yellow in the color interface).

As shown in FIG. 8, in response to the instruction of replenishing ammunition received by the client device, the third display state further includes a dynamic display process as shown in FIGS. 8(a)-(f). FIG. 8(a) shows a display state of the front sight when two pieces of ammunition (two bullets or two cartridge clips) have been fired based on FIG. 7. After the client device receives the instruction of replenishing ammunition from the user, as shown in FIG. 8(b), at the gap between the two arcs (the 12 o'clock position and the 6 o'clock position) that are displayed to be empty, a newly added arc is displayed, and the added arc is displayed as full of ammunition (full cartridge clip). As shown in FIG. 8(c), based on the display state of the front sight as shown in FIG. 8(b), all four arcs (the arcs displayed as a state of being empty and the arcs displayed as a state of being full of ammunition) simultaneously display a shrinking effect in the direction of the arrow, that is, towards the center of the circle. During the shrinking process, all the above arcs (displayed as a state of being empty and displayed as a state of being full of ammunition) are evenly distributed along a virtual circle, so that the newly added arc corresponding to be full of ammunition is embedded between the existing arc corresponding to the empty cartridge clip. As shown in FIG. 8(d), the front sight display state shown in FIG. 8(c) is rotated 90° clockwise as a whole (in other embodiments, may be rotated 60° or 30°, depending on the number of arcs corresponding to the ammunition quantity), and exchanging is performed between the positions of the arcs corresponding to the full cartridge clip and the positions of the arcs corresponding to the empty cartridge clip. As shown in FIG. 8(e), the dynamic effect of the expansion of the front sight is displayed according to the direction pointed by the arrow away from the center of the circle, and the arc used to display the empty cartridge clip is discarded during the expansion process, and only the arc shown in FIG. 8(f) is retained, that is, the newly added arc corresponding to the full cartridge clip is displayed, so that the prompt of changing the cartridge clip is completed.

The embodiments shown in FIG. 7 and FIG. 8 display the use of ammunition and replenishing prompts on the front sight in a dynamic manner, so that the player can accurately predict the number of attacks and the potential attack output capability owned by the player, and this is helpful for the player to obtain the victory of the game.

FIGS. 9-11 show a more comprehensive embodiment for a virtual weapon for triple-loaded ammunition. This embodiment combines the second display state and the third display state.

FIG. 9 shows an image of the front sight displayed by adding 3 rounds of ammunition on the basis of the standard front sight in FIG. 3. In the figure, the virtual circle where the dark gray arc used to mark the ammunition quantity is located is concentric with the circle of the standard front sight, and the virtual circle and the circle of the standard front sight partially overlap without affecting their respective representations.

FIG. 10 shows a prompt of an ammunition consumption process of a virtual weapon during continuous shooting. In order to better match a situation in which when the real gun bursts, the gun barrel is rotated (such as a revolver or a heavy machine gun), in response to the burst operation of the user, each time a bullet is fired (see FIGS. 10 (a)-(c)), the three arcs shown in FIG. 9 are synchronously rotated clockwise along the above virtual circle by a predetermined angle, such as 120°. FIG. 9 shows three dark gray arcs (in the color interface, the color of the arcs can be displayed as bright yellow), and each time a piece of ammunition (such as a bullet) is fired, the color of the arc indicating the ammunition quantity changes to light gray (in the color interface, the color of the arc can be displayed as dark yellow), and the arc is slightly separated from the virtual circle, as shown in FIGS. 10(a)-(c). In addition, FIGS. 10(a)-(c) further show that the temperature of the gun barrel gradually increases with the firing of bullets, that is, FIGS. 10(a)-(c) further successively show the first circle with a gradually increasing radius (the first circle can be displayed in red in a color interface). After the third bullet is fired, the temperature of the gun barrel reached the overheated state again. FIG. 10(d) shows the display state of the front sight after the virtual weapon is cooled down and the cartridge clip is full of ammunition.

FIG. 11 shows a prompt of a process of cooling down a virtual weapon and replacing ammunition. Similar to the principle shown in FIG. 6, in FIG. 11(a), the dark gray second circle (the concentric circle can be displayed as red in the color interface) is gradually decreasing in the counterclockwise direction, and this indicates that the virtual weapon is cooling down. The light gray arc representing the empty cartridge clip (the concentric circle can be displayed as light yellow in the color interface) moves in a direction away from the center of the circle, and this indicates that the empty cartridge clip is removed. In this embodiment, the newly added magazines are not displayed in the form of animations, but directly display three gray arcs that mark the full magazines (the concentric circle can be displayed as yellow in the color interface). The front sight in FIG. 11(b) is the same as the initial front sight shown in FIG. 9, and this indicates that both cooling down of the virtual weapon and ammunition replenishing have been completed.

The present invention further discloses a computer-readable storage medium. At least one computer instruction is stored in the computer-readable storage medium, and the at least one instruction is loaded and executed by a processor to implement the above method.

The present invention further discloses a computer program product. The computer program product includes a computer program/instruction. When the computer program/instruction is executed by a processor, the above method is implemented.

In conclusion, the display state of the front sight is optimized in the present invention, so that the player can know multiple attributes of the virtual weapon by observing the state of the front sight, and there is no need to occupy too much screen display area. The charge attack skill is combined with the overheating mechanism by using the gameplay design, so that better playability is provided.

In the description provided herein, numerous specific details are described. However, it is understood that embodiments of the present invention may be practiced without these specific details. In some instances, well-known methods, structures and techniques have not been shown in detail in order not to obscure the understanding of this description.

It should be noted that the order of the above embodiments of the present invention is only for description, and does not represent the advantages and disadvantages of the embodiments. And the above describes the specific embodiments of this specification. Other implementations are within the scope of the following claims. In some cases, the actions or steps recited in the claims can be performed in an order different from that in the embodiments and still achieve desirable results. In addition, the processes depicted in the accompanying figures do not necessarily require the particular order shown, or sequential order, to achieve desirable results. Multitasking and parallel processing are also possible or may be advantageous in certain embodiments.

It should be appreciated that in the above description of exemplary embodiments of the present invention, in order to streamline the present invention and to facilitate an understanding of one or more of the various inventive aspects, various features of the invention are sometimes grouped together in a single embodiment, figure, or in its description. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed implementation are hereby expressly incorporated into this detailed implementation, with each claim standing on its own as a separate embodiment of the present invention.

Those skilled in the art can understand that the modules in the device in the embodiment can be adaptively changed and arranged in one or more devices different from the embodiment. Modules or units or components in the embodiment may be combined into one module or unit or component, and furthermore may be divided into a plurality of sub-modules or sub-units or sub-components. All features disclosed in this description (including accompanying claims, abstract and drawings), as well as all processes or units of any method or device may be used in any combination, except that at least some of such features and/or processes or units are mutually exclusive. Each feature disclosed in this description (including accompanying claims, abstract and drawings) may be replaced by alternative features serving the same, equivalent or similar purpose, unless expressly stated otherwise.

Furthermore, those skilled in the art can understand that although some embodiments described herein include some features included in other embodiments but not other features, combinations of features from different embodiments are meant to be within the scope of the invention and form different embodiments. For example, in the claims, any one of the claimed embodiments can be used in any combination.

1. A method for controlling a virtual weapon, applied to a client device, comprising:
when the virtual weapon enters an aiming state, displaying a standard front sight state of a front sight of the virtual weapon on the client device, wherein a center point of the standard front sight state points to a target to be aimed at; and
when an attribute of the virtual weapon changes in response to a firing operation, correspondingly changing a display state of the front sight on the client device, wherein the display state includes at least one of the following: a shape of the front sight, a color of the front sight, and one or more dynamic changes of the display state.

2. The method according to claim 1, wherein when the firing operation triggers a charge attack skill, the display state of the front sight is changed to a first display state for indicating a degree of charge, and the first display state comprises displaying a process in which a first circle gradually appears from a 0 o'clock position to a 12 o'clock position by using the center point of the standard front sight state as a center of the first circle.

3. The method according to claim 1, wherein when the firing operation meets a heating condition of the virtual weapon, the display state of the front sight is changed to a second display state for indicating a degree of heating of the virtual weapon, and the second display state comprises:
with an increase of the degree of heating, displaying a second circle whose radius gradually expands by using the center point of the standard front sight state as a center of the second circle, and when the degree of heating reaches a predetermined first threshold, fixing the radius of the second circle as a preset maximum radius.

4. The method according to claim 3, wherein when the firing operation does not meet the heating condition, the second display state further comprises: with the decrease of the degree of heating, displaying a process in which the second circle gradually shrinks to the center of the second circle.

5. The method according to claim 3, wherein when the radius of the second circle is fixed as a preset maximum radius, the second display state further comprises: with a decrease of the degree of heating, displaying a process in which a circle with the maximum radius gradually disappears in a counterclockwise direction from a 12 o'clock position to a 0 o'clock position.

6. The method according to claim 1, wherein when multiple attributes of the virtual weapon simultaneously change, multiple display states are simultaneously displayed on the client device.

7. The method according to claim 1, wherein the display state of the front sight further comprises a third display state for indicating a current quantity of ammunition, and the third display state comprises:
displaying multiple arcs around the center point of the standard front sight state, wherein the multiple arcs are located on a virtual circle that uses the center point as a center of the virtual circle, and one arc represents one piece of ammunition.

8. The method according to claim 7, wherein,
when it is preset to keep displaying the quantity of ammunition, the front sight keeps displaying the third display state; and
when it is not preset to keep displaying the quantity of ammunition, the front sight displays the third display state in response to an aiming operation until the firing operation is completed.

9. The method according to claim 7, wherein the multiple arcs include a first arc, and a first frame line having a color different from the color of the first arc arranged on one side of the first arc, and when the ammunition corresponding to the first arc is used up, only the first frame line is displayed.

10. The method of claim 7, wherein the multiple arcs include a second arc having a first color, and when the ammunition corresponding to the second arc is used up, the color of the second arc is displayed as a second color.

11. The method according to claim 7, wherein in response to an operation of replenishing the ammunition, the third display state further comprises:
displaying a newly-added arc at a gap between the multiple arcs, and displaying the newly added arc in a color different from a color of each of the multiple arcs;
simultaneously shrinking the newly added arc and the multiple arcs, toward the center of the virtual circle, so that the newly added arc is embedded between the multiple arcs;
taking, by the front sight in the third display state, the center point of the standard front sight state as a center of a circle, and rotating a predetermined angle around the center of the circle; and
simultaneously expanding the newly added arc and the multiple arcs in a direction away from the center of the circle, and when the expansion ends, displaying no multiple arcs, and displaying only the newly added arc.

12. An apparatus comprising:
a processing system configured to output at least one video display signal; and
a video display monitor configured to receive the video display signal, wherein when a virtual weapon enters an aiming state, the processing system generates the video display signal to display a standard front sight state of a front sight of the virtual weapon on the video display monitor, wherein a center point of the standard front sight state points to a target to be aimed at, wherein when an attribute of the virtual weapon changes in response to a firing operation, the processing system, via the video display signal, correspondingly changes a display state of the front sight on the video display monitor, and wherein the display state includes at least one of the following: a shape of the front sight, a color of the front sight, and one or more dynamic changes of the display state.

13. (canceled)

14. (canceled)
